(19) United States
(12) Patent Application Publication
(10) Pub. No.: US 2008/0030374 A1
(43) Pub. Date: Feb. 7, 2008

(54) On-board device for detecting vehicles and apparatus for controlling headlights using the device

(75) Inventors: Hiroaki Kumon, Oobu-shi (JP); Kenji Kobayashi, Oobu-shi (JP); Yukimasa Tamatsu, Okazaki-shi (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/888,868

(22) Filed: Aug. 2, 2007

(30) Foreign Application Priority Data
Aug. 2, 2006 (JP) 2006-211324

(51) Int. Cl. G08G 1/017

(52) U.S. Cl. 340/937

(57) ABSTRACT

A device for detecting a vehicle comprises an image capturing an image of a view in front of the own vehicle. The apparatus comprises first and second determining means, distance detecting means, and storing means. Of these, in the storing means, a relationship between distances to light sources of vehicles and a range of levels of a signal to be imaged at light sources is previously stored. The first determining means determines a particular area in data of the captured image, the particular area being defined by pixels having signal levels higher than a predetermined level. The distance detecting means detects a distance from the image sensor to a position at which the particular area is imaged. The second determining means determines whether or not the particular area is the light source, by referring the detected distance and a signal intensity of the determined particular area to the relationship.

### CROSS-REFERENCE TO RELATED APPLICATION

This application is based on and claims the benefit of priority from earlier Japanese Patent Application No. 2006-211324 filed on Aug. 2, 2006, the description of which is incorporated herein by reference.

### BACKGROUND OF THE INVENTION

1. Field of the Invention

The present invention relates to an on-vehicle device for detecting vehicles, such as preceding vehicles and/or oncoming vehicles at night, and an apparatus for controlling headlights using the device.

2. Description of the Related Art

Conventionally, a following on-board driving support device is known. The on-board driving support device detects a preceding vehicle, an oncoming vehicle, and the like at night, presents a display and issues warnings to a driver, and controls on-board equipment. For example, the on-board driving support device controls switching between a low-beam headlight and a high-beam headlight and controls windshield wipers to ensure visibility. The on-board driving support device reduces driving-related load placed on the driver and contributes to road safety. The preceding vehicle and the oncoming vehicle are required to be accurately detected to allow the on-board driving support device to perform appropriate control.

As a vehicle detecting device that can detect the preceding vehicle and the oncoming vehicle at night, there is a vehicle detecting device including an image sensor and an image processing device. The image processing device processes an image picked up by the image sensor. For example, Japanese Patent Laid-open Publication No. 2004-189229 discloses a system used to detect rear lights of a preceding vehicle and headlights of an oncoming vehicle. The system includes an optical system for capturing an image and an image processing system for processing the captured image. According to the system described in Japanese Patent Laid-open Publication No. 2004-189229, the preceding vehicle and the oncoming vehicle are detected through extraction of an intense white light from the headlights and an intense red light from the rear lights. The system takes advantage of a law regulating the brightness, the intensity, and the color of the headlights and the rear lights on a vehicle.

Specifically, the optical system is provided with a lens formed using a red filter dye and a lens formed using a greenish-blue filter dye. Incoming light from a light source is converged in two areas of the image sensor. At this time, one lens extracts red components from the incoming light. The other lens extracts blue components from the incoming light. When a red light or a white light exceeding a predetermined luminance (brightness or signal level) is detected, the light is determined to be the rear lights of the preceding vehicle or the headlights of the oncoming vehicle.

However, in the conventional technology, to extract the red light from the rear lights and the white light from the headlights, the two lenses having the filtering function divide the incoming light into the red light and light of another color. The divided lights are converged. When a lens including a filtering function such as these is used, deterioration of the filtering function becomes a problem in a special environment with drastic temperature fluctuations, such as a vehicle. Furthermore, the optical system becomes complicated because a plurality of lenses having filtering functions such as these is included. As a result, costs increase.

Therefore, the rear lights of the preceding vehicle and the headlights of the oncoming vehicle are ideally identified from only luminance (signal level) information, without using color information as is required in the conventional technology. However, disturbance lights, such as a light from a reflector mounted on a side of a road or a light from a streetlamp, are also included in the image taken by a camera mounted on the vehicle, in addition to the rear lights of the preceding vehicle and the headlights of the oncoming vehicle. Therefore, to detect the preceding vehicle and the oncoming vehicle at night using the camera and the image processing device, the light from the rear lights of the preceding car and the light from the headlights of the oncoming car are required to be differentiated from disturbance lights, particularly the light from a strong reflector. Although the reflector itself does not emit light, the light from the headlights on the vehicle on which the camera is mounted (referred to, hereinafter, as “own vehicle”) is reflected. Therefore, the reflector is shown by the camera to be a light source.

### SUMMARY OF THE INVENTION

The present invention has been achieved in light of the above-described issues. An object of the invention is to provide a vehicle detecting device that can detect a preceding vehicle and an oncoming vehicle and a headlight (or headlamp) controlling apparatus using the vehicle detecting device. The vehicle detecting device detects the preceding vehicle and the oncoming vehicle by identifying a light source equivalent to a light (or lamp) on the vehicle based on brightness information, without using color information.

To achieve the object described above, a vehicle detecting device according to one aspect of the present invention includes an image sensor, a distinguishing means, a distance detecting means, a storing means, and an identifying means. The image sensor is mounted on an own vehicle to image the front of the own vehicle. The distinguishing means distinguishes a light source area within image data picked up by the image sensor that corresponds to a light source and has a luminance equal to or higher than a predetermined value. The distance detecting means detects a distance to the light source. The storing means stores a relationship between the distance to the light source and a luminance range within the light source area. The stored relationship is that of when the light source is a headlight or a rear light. The identifying means collates the relationship between the distance to the light source detected by the detecting means and the luminance of the light source area distinguished by the distinguishing means with the relationships stored in the storing unit. The identifying means also identifies the light source area of which the light source is the headlight of an oncoming vehicle or the rear light of a preceding vehicle. The oncoming vehicle and the preceding vehicle can be detected from the identification result from the identifying means.

When the oncoming vehicle and the preceding vehicle are present at the same distance from the own vehicle, the headlight of the oncoming vehicle is the brightest and the rear light of the preceding vehicle is darker than the headlight of the oncoming vehicle in the image data. When a light from a reflector is also shown in the image data, the light from the reflector is even darker than the rear light because the reflector is not a light source. At the same time, the farther the light from the light on the vehicle and the light from the reflector are, the darker they are observed to gradually become by the image sensor receiving the lights. A reason for this is as follows. When the light source such as the headlight is at a relatively close distance from the own vehicle, the light from the light source is picked up over a plurality of light-receiving elements within the image sensor. Therefore, the luminance is a constant value. However, when the light source is far, the light is only picked up within a single light-receiving element within the image sensor. In this state, the percentage of the light source in the light-receiving elements within the image sensor decreases as the distance becomes longer. Therefore, the luminance decreases.

Here, the size of the light on the vehicle is constant to a certain extent. The brightness of the light is also regulated by law. Therefore, a certain correlation is established between the distance from the own vehicle and the luminance observed by the image sensor.

Therefore, when the light of the vehicle is the light source, the luminance range to be measured by the image sensor can be set in advance at each distance. A relationship between distance and luminance such as this is stored. As a result of the relationship between the luminance actually measured by the image sensor and the distance to the light source being collated with the stored relationships, whether the light source is the headlight or the rear light of the vehicle can be identified. Therefore, in the present invention, the oncoming vehicle and the preceding vehicle can be detected using an optical system including an image sensor that has superior durability and cost-performance.

As another aspect of the present invention, the storing means preferably stores the relationship between the distance to the light source and the luminance range within the light source area when the light source is the reflector mounted on the side of the road. The identifying unit also preferably identifies the light source area of which the light source is the reflector. The reflector is almost constant in size, as is the light on the vehicle. Therefore, a relationship between the distance and the luminance range when the reflector reflects the headlight of the own vehicle can be set in advance. As a result of the relationship between the distance and the luminance range regarding the reflector being stored, the stored relationship regarding the light on the vehicle or the reflector with which the relationship between the actually detected distance and the luminance matches the most can be accurately determined. Thus, the reflector that is a disturbance can be prevented from being identified as the light on the vehicle.

As another aspect of the present invention, the distance detecting means can detect the distance to the light source using the distance between a left light and a right light of the headlights of the oncoming vehicle and of the rear lights of the preceding vehicle. When the distance to the oncoming vehicle and the preceding vehicle is relatively close, the left light and the right light are respectively imaged by different image sensors. The distance between the left light and the right light of the vehicle is almost constant. Therefore, the distance to the vehicle can be calculated from the distance between the left light and the right light on the image sensor.

At the same time, when the oncoming vehicle and the preceding vehicle are positioned at a distance far from the own vehicle, the image sensor cannot identify the left light and the right light. The image sensor recognizes the lights as a single light source. In this case, as another aspect of the present invention, the distance detecting means includes a behavior detecting means that detects the behavior of the own vehicle. Based on the behavior of the own vehicle detected by the behavior detecting means, the distance detecting means can detect the distance to the light source corresponding to the light source area from the position of the light source area in the image data, taking into consideration an amount by which an imaging direction of the image sensor has shifted. The image sensor can be mounted on the own vehicle so that the imaging direction is a reference direction set in advance. Under the assumption that the reflector and the lights on the vehicle are at an average height from the road and the road is flat, the distance to the light source can be calculated from the position of the light source in the image data. However, when the velocities in the vertical and/or horizontal directions of the vehicle are accelerated, the vehicle swings or moves in the pitch direction and the roll direction. In accompaniment with the swinging motions, the imaging direction of the image sensor also shifts from the reference direction. Therefore, the own vehicle behavior is required to be detected and the position of the light source is required to be adjusted by the amount by which the imaging direction has shifted.

As another aspect of the present invention, the headlight controlling apparatus includes the above-described vehicle detecting device. The headlight controlling apparatus includes a controlling means that controls a direction of the headlight of the own vehicle based on the oncoming vehicle and preceding vehicle detection result from the vehicle detecting device.

When the light on the oncoming vehicle or the preceding vehicle is detected using the image sensor, the detectable distance is, for example, 600 meters or more. In this way, the vehicle detecting device can detect a vehicle that is far away. Therefore, direction of the headlights can be appropriately controlled by being switched between, for example, a low beam when another vehicle is detected within a predetermined distance range from the own vehicle to prevent blinding the driver of the other vehicle and a high beam to ensure visibility when other vehicles are not detected.

### BRIEF DESCRIPTION OF THE DRAWINGS

In the accompanying drawings:

FIG. 1A is a block diagram of a headlight controlling apparatus including a vehicle detecting device according to an embodiment;

FIG. 1B is a conceptual view of the headlight controlling apparatus mounted in a vehicle;

FIG. 2 is a view explaining an own vehicle, a preceding vehicle and an oncoming vehicle which run on the same road

FIG. 3 is a graph showing results of an actual measurement of a relationship between distance and luminance regarding various light sources;

FIG. 4 is a flowchart of an overall vehicle detecting process performed by a vehicle-detection controlling unit;

FIG. 5 is a flowchart of details of the vehicle detecting process;

FIG. 6 is a flowchart of details of a light source area extracting process;

FIG. 7 is a flowchart of details of a distance calculating process;

FIG. 8 is a flowchart of details of a light source identifying process;

FIG. 9 explains a light-pair-dependent distance calculating process; and

FIG. 10 explains a single-light-dependent distance calculating process.

### DETAILED DESCRIPTION OF THE PREFERRED EMBODIMENT

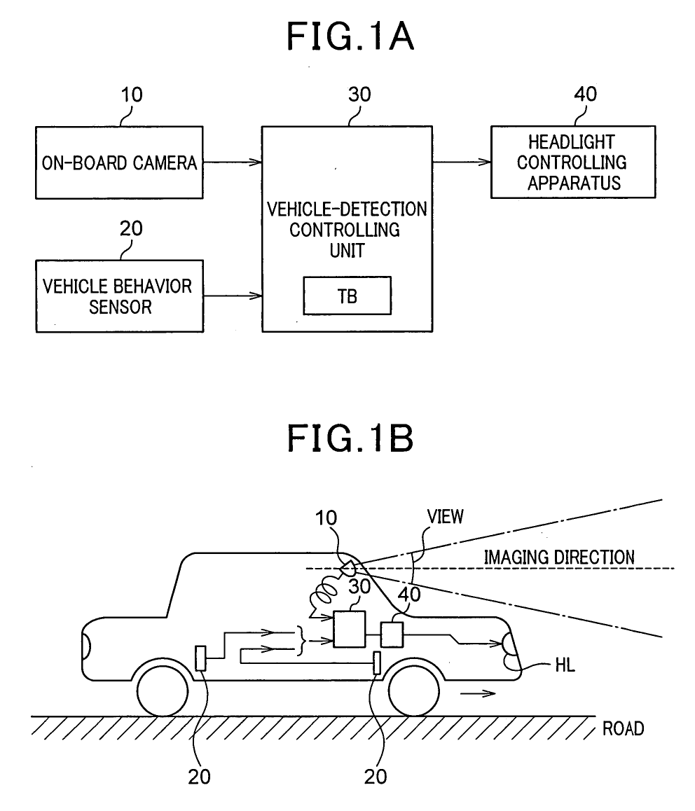

Referring to FIGS. 1A and 1B to FIG. 10, an embodiment of the present invention will now be described in detail.

FIG. 1A is a block diagram of a configuration of a headlight controlling apparatus according to an embodiment of the present invention. In the present headlight controlling apparatus, a vehicle detecting device according to the present invention is functionally reduced in practice. The vehicle detecting device according to the embodiment can be applied not only to the headlight controlling apparatus, but also, for example, to a driving support device. The driving support device detects a preceding vehicle, an oncoming vehicle, and the like at night, and presents a display and issues warnings to a driver.

As shown in FIG. 1B, the headlight controlling apparatus is provided with an on-board camera 10 serving as the image sensor, a vehicle behavior sensor 20, a vehicle detection controlling unit 30, and a headlight controlling unit 40.

Of these, the on-board camera 10 is mounted on an own vehicle to allow imaging of the front of the own vehicle. The on-board camera 10 includes, for example, an image sensor of which a light-receiving element is a charge-coupled device (CCD). The on-board camera 10 is mounted on the own vehicle and fixed so that an imaging direction of the on-board camera 10 matches a predetermined reference direction (for example, a horizontal direction) when imaging the front of the own vehicle.

The on-board camera 10 is configured so that the shutter speed, the frame rate, the gain of a digital signal outputted to a vehicle-detection controlling unit 30, and the like, can be adjusted depending on an instruction from an internal controlling unit (not shown). The on-board camera 10 outputs a digital signal indicating the luminance (brightness or signal level) of each pixel within the picked-up image to the vehicle detection controlling unit 30 as image data, in addition to a horizontal and vertical synchronizing signal of the image.

A vehicle behavior sensor 20 includes a stroke sensor mounted, for example, on a four-wheel suspension system of the own vehicle. The vehicle behavior sensor 20 detects behavioral changes in a pitch direction and a roll direction of the own vehicle. When the own vehicle runs and the velocity in the back-and-forth and lateral directions of the vehicle accelerate the body of the own vehicle swings or moves in the pitch direction and the roll direction. In accompaniment with the swinging motions, the imaging direction of the on-board camera 10 also shifts from the reference direction. The vehicle behavior sensor 20 provides the vehicle-detection controlling unit 30 with vehicle behavior information used to calculate how much the imaging direction of the on-board camera 10 has shifted from the reference direction.

The vehicle-detection controlling unit 30 performs image processing on the image data inputted from the on-board camera 10, taking into consideration the above-described vehicle behavior information. As a result, the vehicle-detection controlling unit 30 identifies to which, among the rear lights (taillights) of the preceding vehicle, the headlight of the oncoming vehicle, and the reflector mounted on the side of the road, a light source included in the image corresponds. When the vehicle-detection controlling unit 30 identifies the light source in the image to be corresponding to the rear light of the preceding vehicle or the headlight of the oncoming vehicle, the vehicle-detection controlling unit 30 outputs detection information related to the preceding vehicle or the oncoming vehicle to a headlight controlling apparatus 40.

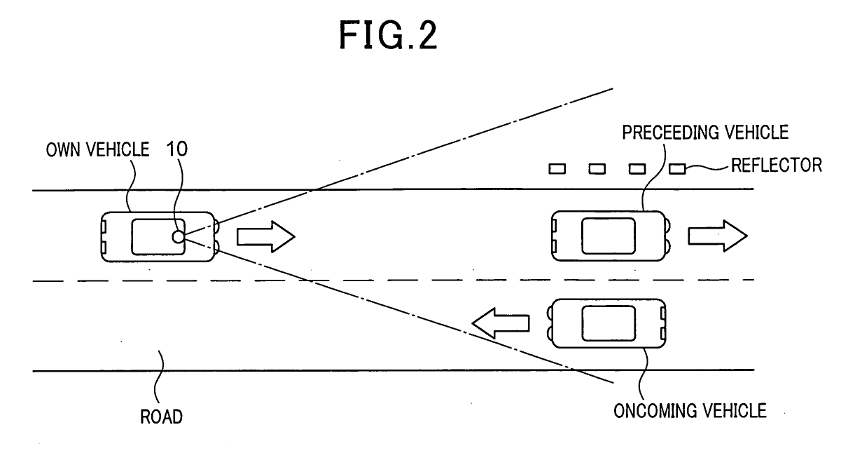

The headlight controlling apparatus 40 controls the direction of headlights HL (headlamps) of the vehicle (refer to FIG. 1B), based on the detection information related to the preceding vehicle or the oncoming vehicle inputted from the vehicle-detection controlling unit 30. For example, when a distance to the preceding vehicle or the oncoming vehicle (refer to FIG. 2) included in the detection information is less than a predetermined distance, the headlight controlling apparatus 40 sets the direction of the headlight to a low beam. As a result, the headlight controlling apparatus 40 prevents a driver of the preceding vehicle or the oncoming vehicle from being blinded by the light from the headlight of the own vehicle.

At the same time, when the distance to the preceding vehicle or the oncoming vehicle is equal to or more than the predetermined distance or the preceding vehicle or the oncoming vehicle is not detected, the headlight controlling apparatus 40 sets the direction of the headlight to a high beam. As a result, the headlight controlling apparatus 40 ensures the driver of the own vehicle has visibility for a longer distance. Because detection is performed based on the image data from the on-board camera 10, the preceding vehicle and the oncoming vehicle that are a relatively long distance away (for example, 600 meters) can be detected. Therefore, the headlight controlling apparatus 40 can appropriately control the direction of the headlight.

Next, a principle behind the preceding vehicle and oncoming vehicle detection performed by the vehicle-detection controlling unit 30 will be described.

When the preceding vehicle and the oncoming vehicle are a same distance away from the own vehicle along the running direction at night and the on-board camera 10 images the preceding vehicle and the oncoming vehicle (refer to FIG. 2), the headlights of the oncoming vehicle are shown to be the brightest in the picked-up image. The rear lights of the preceding vehicle are shown to be darker than the headlight of the oncoming vehicle. When the light from the reflector is also shown in the image, the light from the reflector is even darker than the rear light of the preceding vehicle because the reflector is not a light source.

At the same time, the farther the headlight of the oncoming vehicle, the rear light of the preceding vehicle, and the light from the reflector are, the darker they are observed to gradually become by the image sensor receiving these lights. A reason for this is as follows. When the light source such as the headlight is a relatively close distance away from the own vehicle, the light from the light source is picked up over a plurality of light-receiving elements within the image sensor. Therefore, the luminance is a constant value. However, when the light source is far, the light is only picked up within a smaller amount of light-receiving elements within the image sensor. In this state, the percentage of the light source in the light-receiving elements within the image sensor decreases as the distance becomes longer. Therefore, the luminance from the light source decreases.

Here, the size of the light on the vehicle is constant to a certain extent. The brightness of the light is also regulated by law. Therefore, a certain correlation is established between the distance from the own vehicle and the luminance observed by the image sensor in the on-board camera 10. The luminance of the light also differs if the light source changes. Therefore, different correlations are established between, for example, when the reflector is the light source and when the light on the vehicle is the light source.

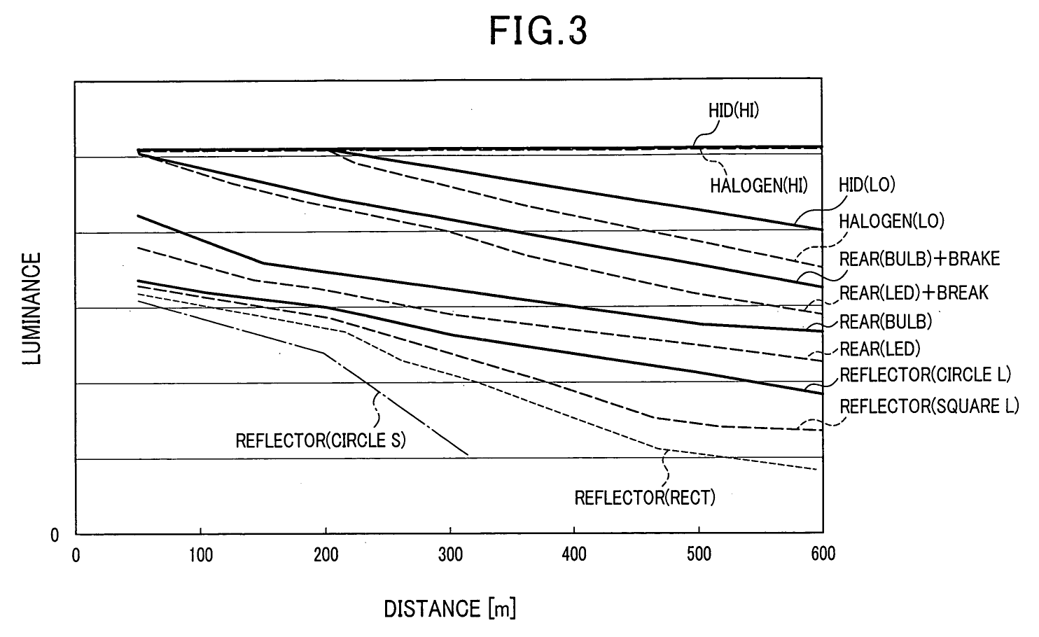

FIG. 3 is a graph showing results of an actual measurement of the relationship between distance and luminance, regarding various light sources. As shown in FIG. 3, it is clear that luminance decreases as the light source becomes farther away from the own vehicle. In addition, the correlation between distance and luminance differs depending on the type of light source. In FIG. 3, the correlation between distance and luminance regarding the following types of light sources is shown.

(1) The headlight of the oncoming vehicle is a so-called discharge light. When the direction of the headlight is the low beam (HID[Lo]) and when the direction is the high beam (HID[Hi]) are shown.

(2) The headlight of the oncoming vehicle is a halogen light. When the direction of the headlight is the low beam (Halogen[Lo]) and when the direction is the high beam (Halogen[Hi]) are shown.

(3) The rear light of the preceding vehicle is a bulb light. When a brake light is simultaneously illuminated (Rear[Bulb]+Brake) and when only the bulb light is illuminated (Rear[Bulb]) are shown.

(4) The rear light of the preceding vehicle is a light-emitting diode (LED) light. When a brake light is simultaneously illuminated (Rear[LED]+Brake) and when only the LED light is illuminated (Rear[LED]) are shown.

(5) When the shape of the reflector is a small circle (Reflector[Circle S]), a large circle (Reflector[Circle L]), a rectangle (Reflector[Rect]), and a large square (Reflector[Square L]) are respectively shown.

As described above, if the light source type differs, the correlation between the distance to the light source and the luminance also differs. Taking advantage of this point, according to the embodiment, the light sources that are the headlight of the oncoming vehicle and the rear light of the preceding vehicle are identified from the image picked up by the on-board camera 10. Specifically, based on the measurement results such as those shown in FIG. 3, the correlation between distances and luminance ranges are measured in advance and stored for each of the same light sources types in a table TB formed by a read-only memory (ROM) or other memory devices in the vehicle-detection controlling unit 30.

The distance to the light source and the luminance of the light source are detected from the image data captured by the on-board camera 10. The relationship between the detected distance and luminance is compared with the stored correlations regarding various light sources. The correlation with which the relationship has a highest probability of correspondence is judged. Then, when the relationship is judged to have the highest probability of correspondence with the correlation corresponding to the headlight of the oncoming vehicle or to the rear light of the preceding vehicle, the light source in the image data is detected as the oncoming vehicle or the preceding vehicle.

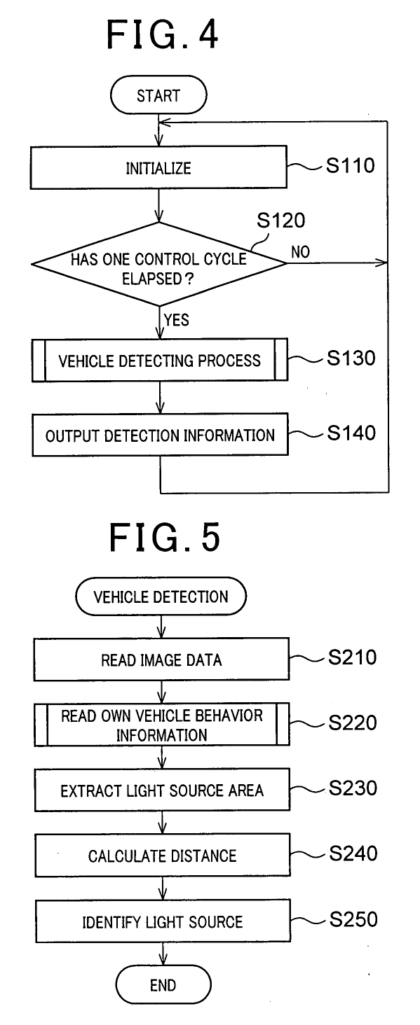

Hereafter, specific procedures performed by the vehicle-detection controlling unit 30 for vehicle detection will now be described with reference to FIG. 4 to FIG. 10.

FIG. 4 is a flowchart of an overall vehicle detection process performed by the vehicle-detection controlling unit 30. First, in an initialization process at Step S110, the vehicle-detection controlling unit 30 clears all values within a not-shown temporary memory and performs initialization. Furthermore, the vehicle-detection controlling unit 30 reads the table TB (equivalent to FIG. 3) showing the relationships between distance and luminance range stored in advance to allow identification of the light source type. Next, at Step S120, the vehicle-detection controlling unit 30 judges whether a period equivalent to a one control cycle has elapsed. At this time, when the vehicle-detection controlling unit 30 judges that one control cycle has elapsed, the vehicle-detection controlling unit 30 proceeds to Step S130 and performs a vehicle detecting process. Details of the vehicle detecting process will be described hereafter. When the vehicle detecting process is completed, the vehicle-detection controlling unit 30 outputs the detection information captured through the vehicle detecting process to the headlight controlling apparatus 40 at Step S140.

FIG. 5 is a flowchart of the details of the vehicle detecting process. In the vehicle detecting process, the vehicle-detection controlling unit 30 performs image processing on the image data picked up by the on-board camera 10 and what appears to be a light source is extracted. The vehicle-detection controlling unit 30 detects the preceding vehicle and the oncoming vehicle by the identifying the light source type.

First, at Step S210, the vehicle-detection controlling unit 30 loads the image data of the front of the own vehicle picked up by the image sensor in the on-board camera 10 into the memory. The image data includes a signal indicating the luminance of each pixel in the image. Next, at Step S220, the vehicle-detection controlling unit 30 loads information related to the behavior of the own vehicle from the vehicle behavior sensor 20.

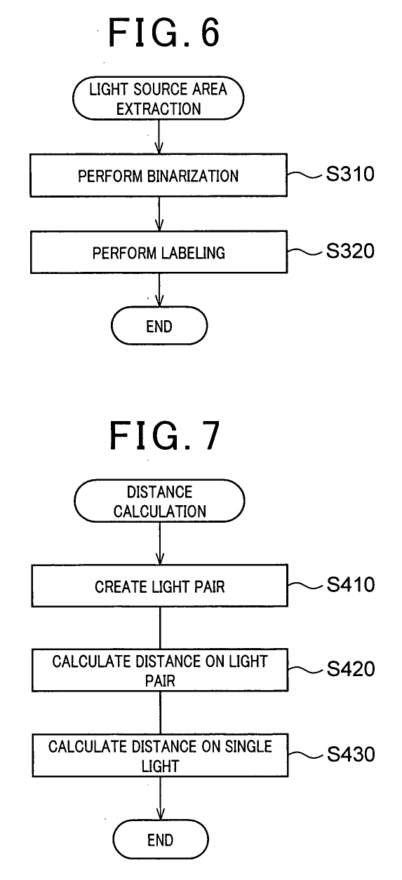

At Step S230, the vehicle-detection controlling unit 30 extracts a light source area with high luminance thought to be the light source, from the image data loaded into the memory. The light source area is a bright area within the image data having a higher luminance than a predetermined threshold luminance. A plurality of light source areas is often present. All of the light source areas are extracted. Details of the light source area extracting process will be described with reference to FIG. 6.

In the light source area extracting process, first, at Step S310, the vehicle-detection controlling unit 30 performs a binarization process by comparing the luminance of each pixel with the predetermined threshold luminance. Specifically, the vehicle-detection controlling unit 30 assigns ‘1’ to a pixel having a luminance that is equal to or more than the predetermined threshold luminance and ‘0’ to other pixels, thereby creating a binary image. Next, at Step S320, when the pixels to which ‘1’ is assigned are near each other within the binary image, a labeling process is performed to recognize these pixels as a single light source area. As a result, the light source area formed from a group of a plurality of pixels is extracted as one light source area.

Returning to FIG. 5, at Step S240 performed after the light source area extracting process described above, the vehicle-detection controlling unit 30 calculates the distance to each light source for each extracted light source area. Details of a distance calculating process will be described with reference to a flowchart in FIG. 7.

In the distance calculating process shown in FIG. 7, the vehicle-detection controlling unit 30 performs a “light-pair-dependent distance calculating process” and a “single-light-dependent distance calculating process.” The light-pair-dependent distance calculating process is used to detect a distance taking advantage of the lights of the vehicle being in a pair, the right and left lights (lamps). The single-light-dependent distance calculating process is performed when the right and left lights cannot be recognized because the distance is long and the lights are recognized as a single light.

First, to perform the light-pair-dependent distance calculating process, at Step S410, the vehicle-detection controlling unit 30 performs a light pair creating process to create a pair of lights. The pair of lights including the left light and the right light fulfills the following conditions in the image data picked up by the on-board camera 10. The lights are positioned close together and at almost the same height. The areas of the light source areas are almost the same. The shapes of the light source areas are the same. Therefore, the light source areas fulfilling these conditions are the light pair. A light source area that cannot be paired is considered to be a single light.

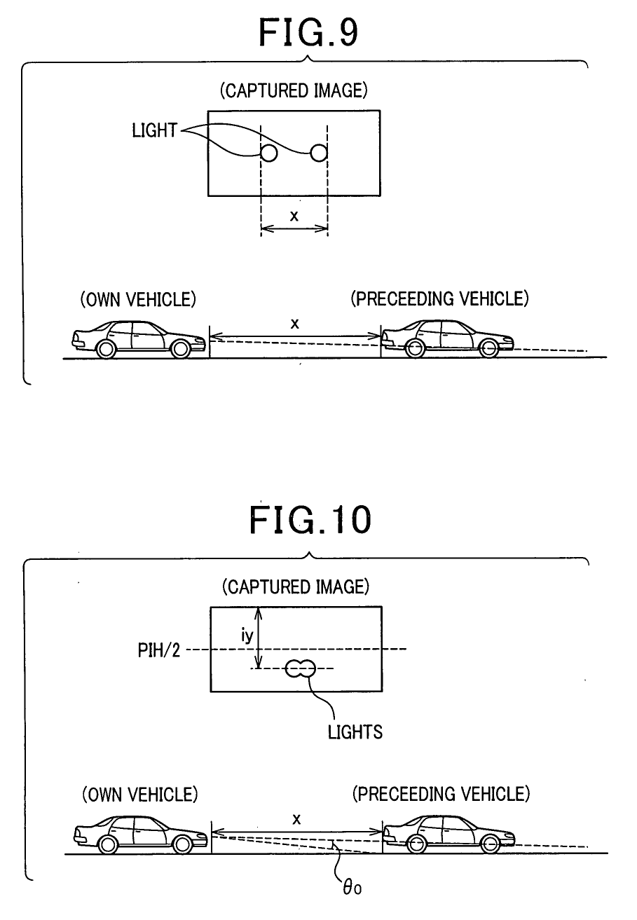

When the light pair is formed as shown in FIG. 9, the vehicle-detection controlling unit 30 calculates the distance to the light pair by the light-pair-dependent distance calculating process at Step S420. The distance between the left headlight and the right headlight on the vehicle and the distance between the left rear light and the right rear light on the vehicle can be approximated by a constant value w0 [mm] (for example, about 1600 [mm]). At the same time, because a focal distance “f [mm]” of the on-board camera 10 is already known and a distance w1 [mm] between the right and left lights on the image captured by the image sensor in the on-board camera 10 is calculated, an actual distance “x [mm or m]” from the own vehicle to the light pair position can be determined (estimated) by calculating, for instance, a simple proportion formula of

x=f·{W0/(W1·Rh)} (1)

where a reference Rh [mm/pix] is a resolution of the captured image. This calculation is established on the assumption that the own vehicle almost directly faces the preceding vehicle or the oncoming vehicle.

At the same time, when the oncoming vehicle or the preceding vehicle is positioned a long distance away from the own vehicle, the image sensor cannot identify the left light and the right light. The lights are recognized as a single light source, mostly as a single elliptical light source, as illustrated in FIG. 10. This is also true when the reflector is the light source. In this way, regarding the light with which a light pair cannot be formed, the distance is calculated by the single-light-dependent distance calculating process at Step S430.

The single-light-dependent distance calculating process at Step S430 is a process to calculate the distance when both left and right lights are recognized as a signal light source. This calculation can also be made on the foregoing formula (I), in which w1 is a width of the single elliptical light on the captured image (refer to FIG. 10).

Alternatively, the single-light-dependent distance calculating process may be done using information indicating a position of the lights on the captured image. The farther the distance, the closer the lights come to the upper end of the captured image. As shown in FIG. 10, provided that the road is planar with no pitching motion, an actual distance “x” between the own vehicle to the preceding vehicle (or oncoming vehicle) can also be estimated on a formula of

x=h·f/((iy−PIH/2)·Rv−θ₀·f) (2),

where h [mm] is the height of the on-board camera 10, f [mm] is a focal distance of the on-board camera 10, Rv [mm/pix] is a resolution of the captured image, PIH [pix] is an height of the captured image, and θ₀ [rad] is a depression angle shown in FIG. 10.

As described above, the on-board camera 10 is mounted on the own vehicle so that the imaging direction is the reference direction determined in advance. When the lights source is the headlight or the rear light of the vehicle, the height of the light source can be approximated by a rough constant distance (for example, 80 centimeters) from the ground. Therefore, under the assumption that the road is flat, the actual distance to the single light source can be calculated from the distance from the lower edge of the image data to the position of the single light source.

However, when the velocities in the back-and-forth and lateral directions of the vehicle are accelerated, the vehicle swings or moves in the pitch direction or the roll direction. In accompaniment with the swinging motions, the imaging direction of the on-board camera 10 also shifts from the reference direction. Therefore, the vehicle-detection controlling unit 30 determines the distance to the single light source by detecting the behavior of the own vehicle using the vehicle behavior sensor 20 and correcting the position of the single light source by the amount of shifting of the imaging direction.

Returning to FIG. 5, at Step S250 performed after the above-described distance calculating process, the relationship between the calculated distance to each light source and the luminance of each light source is applied to the relationships stored in advance. The probability of correspondence regarding each stored relationship is calculated. Then, the vehicle-detection controlling unit 30 judges each light source area extracted by the image sensor to be the light source type with which the light source area has a relationship with the highest probability of correspondence.

As a result, the vehicle-detection controlling unit 30 can identify whether the light source picked up by the image sensor is the headlight of the vehicle, the rear light of the vehicle, or a reflector that is a disturbance light. Regarding the luminance of each light source, a maximum luminance within the light source area or an average luminance can be used.

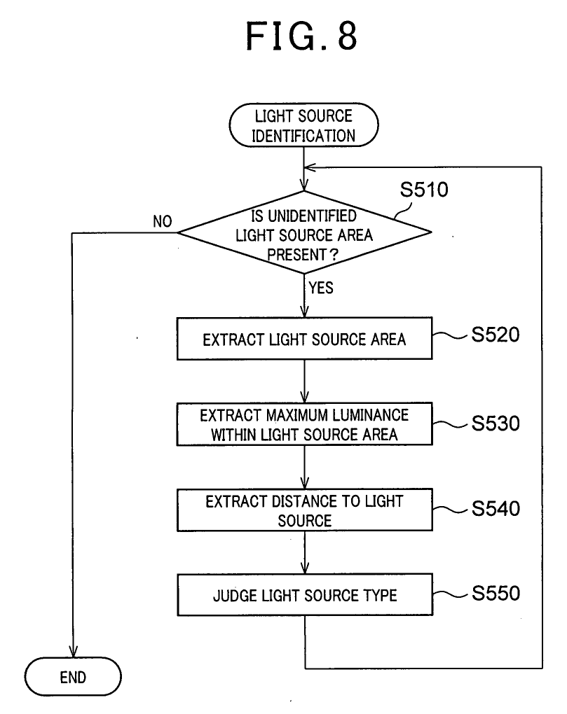

FIG. 8 is a flowchart of the details of the light source identifying process. First, at Step S510, the vehicle-detection controlling unit 30 judges whether a light source area of which the type is unidentified is present within the image data captured by the image sensor. In the judging process, no light source area is present within the image data or the light source type of all light source areas have been identified, the process in the flowchart in FIG. 8 is completed. At the same time, at Step S510, when the vehicle-detection controlling unit 30 judges that a light source area of which the light source type is unidentified is present, the vehicle-detection controlling unit 30 proceeds to Step S520.

At Step S520, the vehicle-detection controlling unit 30 extracts the light source area of which the light source type is still unidentified from the memory. At Step S530, the vehicle-detection controlling unit 30 extracts a maximum luminance value of the light source area. At Step S540, the distance calculated at Step S420 or Step S430 in the flowchart in FIG. 7 is extracted.

Then, at Step S550, the calculated distance and the maximum luminance value are applied to the relationships between distance and luminance range stored in advance. The probability of correspondence is calculated for each stored relationship. The light source area is judged to be the light source type with the highest probability of correspondence.

In the case shown in FIG. 3, headlights belong to the area on the upper side of the curve “HALOGEN (LO),” rear lights belong to the area between the curves “REAR (BULB)+BRAKE” and “REAR (LED),” and reflectors belong to the area on the lower side of the curve “REFLECTOR (CIRCLE L).” In this case, the areas are clearly separated from each other depending on the types of light sources, so that, if noise (arbitrarily chosen amount) is set to 10%, probabilities of “headlight, rear light, reflector”=“80, 10, 10”, “10, 80, 10”, and “10, 10, 80” % are given to a light source to be determined.

In addition, when if the curves “Rear (LED)” and “Reflector (Circle L) are switched to each other in FIG. 3, probabilities of “headlight, rear light, reflector”=“10, 45, 45” % with 10% noise are given to a light source to be determined and the probabilities, and subjected to accumulation using for example a low-pass filter. When any of the accumulated probabilities for the headlight, rear light, and reflector exceeds a given value, for example, 80%, it can be determined that the light source has the type shown by the probability exceeding the given value.

Instead of giving probabilities of “headlight, rear light, reflector”=“10, 45, 45” % with 10% noise, probabilities on interpolation may be given depending on a condition where a correlational point between the luminance and the distance is positionally closer to which one of the mutually switched curves “Rear (LED)” and “Reflector (Circle L) in FIG. 3.

The exemplary embodiment of the present invention has been described above. However, the present invention is not limited in any way to the above-described embodiment. Various modifications can be made to the invention without departing from the scope of the invention.

For example, according to the embodiment, the light source type is identified from the relationship between the luminance of the light source and the distance to the light source, such as those shown in FIG. 3. However, when the light source type is identified based only on the relationship, the light source type may be mistakenly judged. Therefore, the light source type can also be collectively judged, taking into account whether the light source is a still object or a moving object, a tracking state of the light source, and the like.

According to the embodiment, the distance to the light source is determined by the light-pair-dependent distance calculating process or the single-light-dependent distance calculating process being performed. However, regarding the distance to the light source, for example, the distance can be detected using a so-called stereo camera or using another sensor (a distance detecting sensor such as a laser radar sensor).

The present invention may be embodied in other specific forms without departing from the spirit or essential characteristics thereof. The present embodiment and modifications are therefore to be considered in all respects as illustrative and not restrictive, the scope of the present invention being indicated by the appended claims rather than by the foregoing description and all changes which come within the meaning and range of equivalency of the claims are therefore intended to be embraced therein.

What is claimed is:

1. A device for detecting a vehicle being targeted by detecting a light source of the vehicle, the vehicle being stationary or running on or along a road on or along which an own vehicle with the device mounted thereon is stationary or runs, the device comprising:
an image sensor capturing an image of a view in front of the own vehicle, the image sensor being mounted positionally fixedly on the own vehicle to have a predetermined preset imaging direction toward the view;
first determining means for determining a particular area in data of the image captured by the image sensor, the particular area being defined by pixels having signal levels higher than a predetermined level;
distance detecting means for detecting a distance from the image sensor to a position at which the particular area is imaged as an object;
storing means for previously storing therein a relationship between distances to light sources of vehicles and a range of levels of a signal to be imaged at the light sources; and
second determining means for determining whether or not the particular area is the light source of the vehicle being targeted, by referring the detected distance and a signal intensity of the determined particular area to the relationship stored in the storing means.

2. The detecting device of claim 1, wherein the light source is at least one of headlights and rear lights of the vehicle being targeted.

3. The detecting device of claim 2, wherein the storing means previously stores therein the relationship including a relationship between distances to a reflector disposed on a side of the road and a range of levels of a signal to be imaged at the light source and
the second determining means is configured to additionally determine whether or not the particular area is an image of the reflector serving as the light source by referring the detected distance and the signal intensity of the determined particular area to the relationship stored in the storing means.

4. The detecting device of claim 2, wherein each of the headlights and rear lights of the vehicle is composed of lateral right and left lights with a distance therebetween and
the distance detecting means is configured to use the distance between the lateral right and left lights of the vehicle to detect the distance.

5. The detecting device of claim 1, further comprising
behavior detecting means for detecting behaviors of the own vehicle,
wherein the distance detecting means is configured to detect the distance corrected based on a shift from the imaging direction using results detected by the behavior detecting means.

6. A control apparatus comprising:
a device for detecting a vehicle being targeted by detecting a light source of the vehicle, the vehicle being stationary or running on or along a road on or along which an own vehicle with the device mounted thereon is stationary or runs, the device comprising:
an image sensor capturing an image of a view in front of the own vehicle, the image sensor being mounted positionally fixedly on the own vehicle to have a predetermined preset imaging direction toward the view;
first determining means for determining a particular area in data of the image captured by the image sensor, the particular area being defined by pixels having signal levels higher than a predetermined level;
distance detecting means for detecting a distance from the image sensor to a position at which the particular area is imaged as an object;
storing means for previously storing therein a relationship between distances to light sources of vehicles and a range of levels of a signal to be imaged at the light sources; and
second determining means for determining whether or not the particular area is the light source of the vehicle being targeted, by referring the detected distance and a signal intensity of the determined particular area to the relationship stored in the storing means; and
control means for controlling light-emitting directions of headlights of the vehicle being targeted.

7. The control apparatus of claim 6, wherein the light source is at least one of headlights and rear lights of the vehicle being targeted.

8. The control apparatus of claim 7, wherein the storing means previously stores therein the relationship including a relationship between distances to a reflector disposed on a side of the road and a range of levels of a signal to be imaged at the light source and
the second determining means is configured to additionally determine whether or not the particular area is an image of the reflector serving as the light source by referring the detected distance and the signal intensity of the determined particular area to the relationship stored in the storing means.

9. The control apparatus of claim 7, wherein each of the headlights and rear lights of the vehicle is composed of lateral right and left lights with a distance therebetween and
the distance detecting means is configured to use the distance between the lateral right and left lights of the vehicle to detect the distance.

10. The control apparatus of claim 6, further comprising
behavior detecting means for detecting behaviors of the own vehicle,
wherein the distance detecting means is configured to detect the distance corrected based on a shift from the imaging direction using results detected by the behavior detecting means.

11. A method of detecting a vehicle being targeted by detecting a light source of the vehicle, the vehicle being stationary or running on or along a road on or along which an own vehicle with the device mounted thereon is stationary or runs, comprising steps of:
capturing an image of a view in front of the own vehicle by an image sensor being mounted positionally fixedly on the own vehicle to have a predetermined preset imaging direction toward the view;
first determining a particular area in data of the image captured by the image sensor, the particular area being defined by pixels having signal levels higher than a predetermined level;
detecting a distance from the image sensor to a position at which the particular area is imaged as an object; and
second determining whether or not the particular area is the light source of the vehicle being targeted, by referring the detected distance and a signal intensity of the determined particular area to a relationship between distances to light sources of vehicles and a range of levels of a signal to be imaged at the light sources.

12. The detecting method of claim 11, wherein the light source is at least one of headlights and rear lights of the vehicle being targeted.

13. The detecting method of claim 12, wherein the relationship including a relationship between distances to a reflector disposed on a side of the road and a range of levels of a signal to be imaged at the light source and
the second determining step additionally determines whether or not the particular area is an image of the reflector serving as the light source by referring the detected distance and the signal intensity of the determined particular area to the relationship.

14. The detecting device of claim 12, wherein each of the headlights and rear lights of the vehicle is composed of lateral right and left lights with a distance therebetween and
the distance detecting means uses the distance between the lateral right and left lights of the vehicle to detect the distance.

15. The detecting device of claim 11, further comprising a step of detecting behaviors of the own vehicle,
wherein the distance detecting means detects the distance corrected based on a shift from the imaging direction using results detected.
